(19) United States
(12) Patent Application Publication
(10) Pub. No.: US 2007/0055519 A1
(43) Pub. Date: Mar. 8, 2007

(54) Robust bandwith extension of narrowband signals

(75) Inventors: Michael L. Seltzer, Seattle, WA (US); Alejandro Acero, Bellevue, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/241,633

(22) Filed: Sep. 30, 2005

Related U.S. Application Data
(60) Provisional application No. 60/713,953, filed on Sep. 2, 2005.

(51) Int. Cl. G10L 15/04

(52) U.S. Cl. 704/251

(57) ABSTRACT

A narrowband power spectrum is converted into a narrowband cepstral vector. A wideband cepstral vector is then estimated from the narrowband cepstral vector, where the wideband cepstral vector represents more frequency components than the narrowband cepstral vector.

### REFERENCE TO RELATED APPLICATIONS

The present application claims priority benefit of U.S. Provisional Application 60/713,953 filed on Sep. 2, 2005 and entitled Robust Bandwidth Extension of Narrowband Signals.

### BACKGROUND

Signals, such as speech and music, transmitted over a telephony network are bandwidth limited to frequencies between 300-3400 Hz. While limiting speech to this bandwidth does not significantly reduce intelligibility, studies have shown that users prefer listening to wideband speech, i.e. speech with a frequency range of 50-8000 Hz. As a result, there has been a significant amount of research performed aimed at enhancing the perceptual quality of narrowband speech by estimating and then synthesizing the missing spectral content in order to artificially extend the bandwidth of the speech.

Most efforts to extend the bandwidth of speech have relied on extending the spectral envelope using LPC-derived features, such as LPC-cepstra or LSF coefficients. However, the all-pole model associated with LPC-derived features is not ideal when attempting to extend the bandwidth of speech and in particular does not perform well with noise-corrupted speech.

The discussion above is merely provided for general background information and is not intended to be used as an aid in determining the scope of the claimed subject matter.

### SUMMARY

A narrowband power spectrum is converted into a narrowband cepstral vector. A wideband cepstral vector is then estimated from the narrowband cepstral vector, where the wideband cepstral vector represents more frequency components than the narrowband cepstral vector.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a computing environment.

FIG. 2 is a block diagram of a mobile device computing environment.

FIG. 3 is a block diagram of elements used to train transformation parameters.

FIG. 4 is a flow diagram of a method of training transformation parameters.

FIG. 5 is a block diagram of a cepstral feature vector extraction unit.

FIG. 6 is a block diagram of elements used to extend narrowband cepstral vectors into wideband cepstral vectors.

FIG. 7 is a block diagram of elements used to extend noisy narrowband cepstral vectors into enhanced wideband cepstral vectors.

FIG. 8 is a flow diagram of a method of forming enhanced wideband cepstral vectors.

FIG. 9 is a block diagram of elements used to form a filter for a noisy narrowband power spectrum.

FIG. 10 is a flow diagram of a method of filtering a noisy narrowband power spectrum.

### DETAILED DESCRIPTION

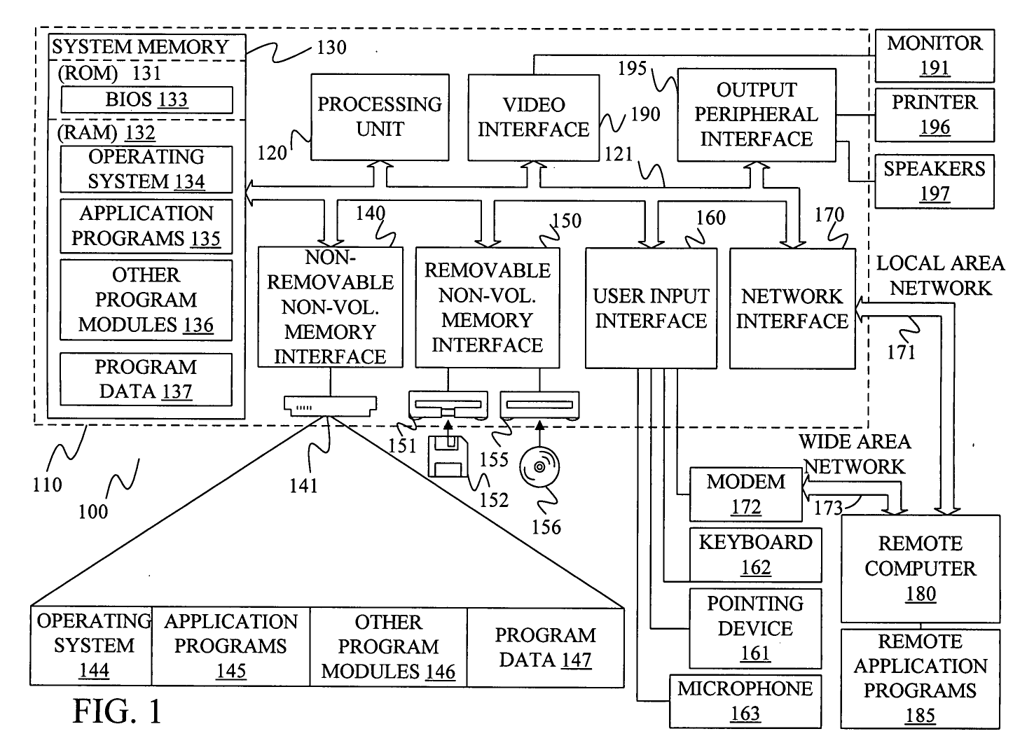

FIG. 1 illustrates an example of a suitable computing system environment 100 on which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

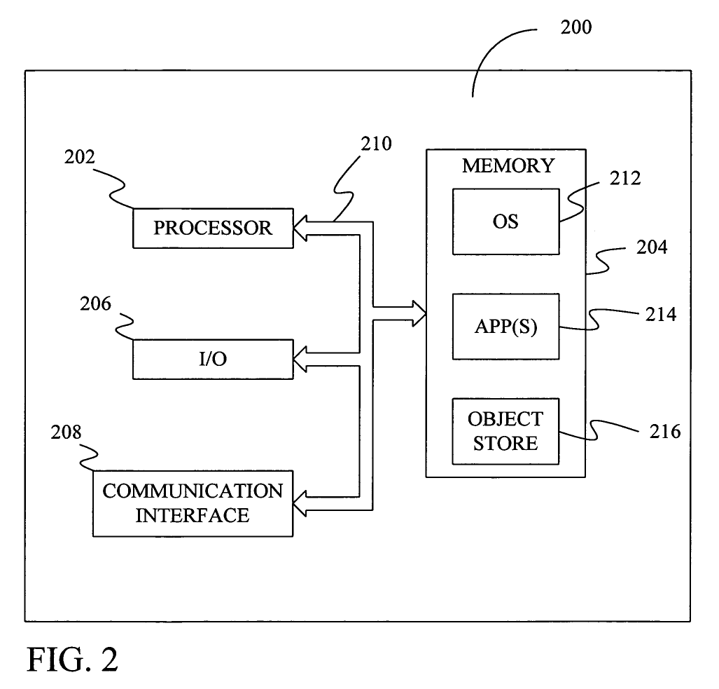

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200.

The present inventors extend narrowband cepstral feature vectors x using a mixture of piecewise linear transformations. For each mixture component or state, the transformation is defined as:
z=Aₛx+bₛ+e EQ. 1
where z is a wideband cepstral feature vector that represents more frequency components than narrowband cepstral vector x, Aₛ and bₛ are transformation parameters for a mixture component or state s, and the e is a noise term that is defined to have a Gaussian probability of p(e)=N(e;0,I). Wideband cepstral feature vector z may have more components than narrowband cepstral feature vector x such that transformation parameter Aₛ has more rows than columns.

EQ. 1 may be rewritten by combining the transformation parameters into a single matrix and extending the narrowband cepstral feature vector by adding an element equal to 1 such that:
Aₛ′=[Aₛbₛ] EQ. 2
and
x′=[x1]^{T} EQ. 3
this results in a new definition of EQ. 3 of:
z=Aₛ′x′+e EQ. 4

Using EQ. 4, an expected value for a wideband cepstral feature vector given a narrowband cepstral feature vector is defined as:

$$E [ z \text{\vert} x ] = {\sum }_{s = 1}^{S} p ( s \text{\vert} x ) {A}_{s}^{′} {x}^{′} \qquad EQ . 5$$

where the summation is taken over all S of the mixture components and p(s|x) is the probability of a mixture component given the narrowband cepstral feature vector. Equation 5 represents a weighted sum of estimates of the wideband cepstral feature vector, with p(s|x) providing the weights. In alternative embodiments, the estimate of the wideband cepstral feature vector generated for the most probable state as determined by p(s|x) is selected as the wideband cepstral value. This essentially sets the weight of the most probable state to 1 and the weight of all other states to 0. In further embodiments, the summation is not performed across all states but is only performed across the top n most probable states. In such embodiments, the weights associated with the top n most probable states are normalized by dividing the probability of each state by the sum of the probabilities of the top n most probable states so that the sum of the weights equals one.

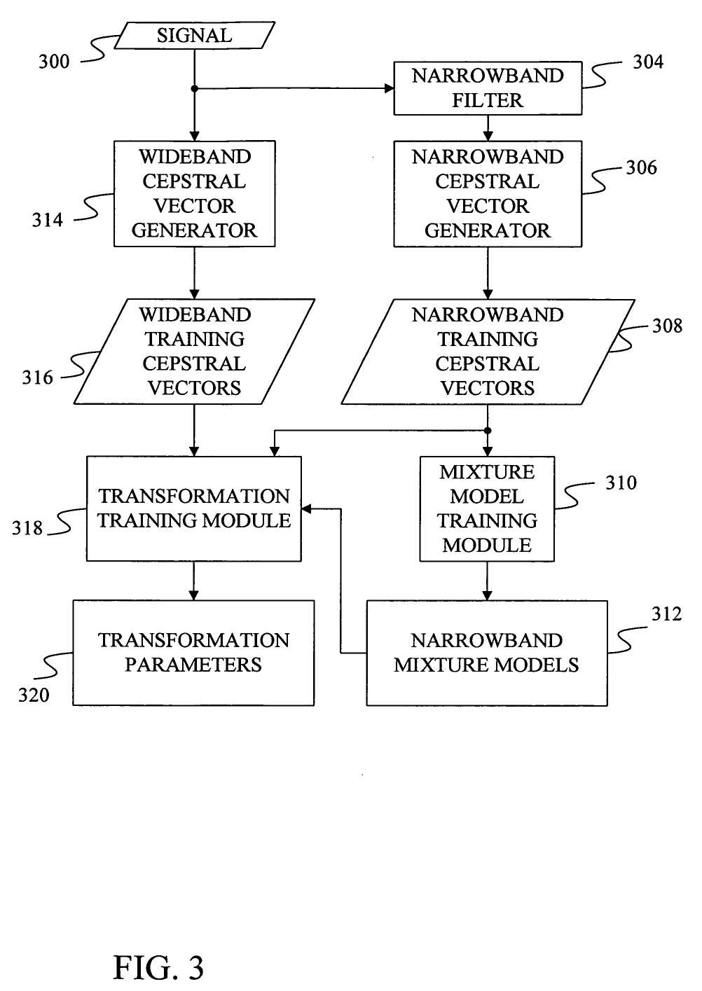

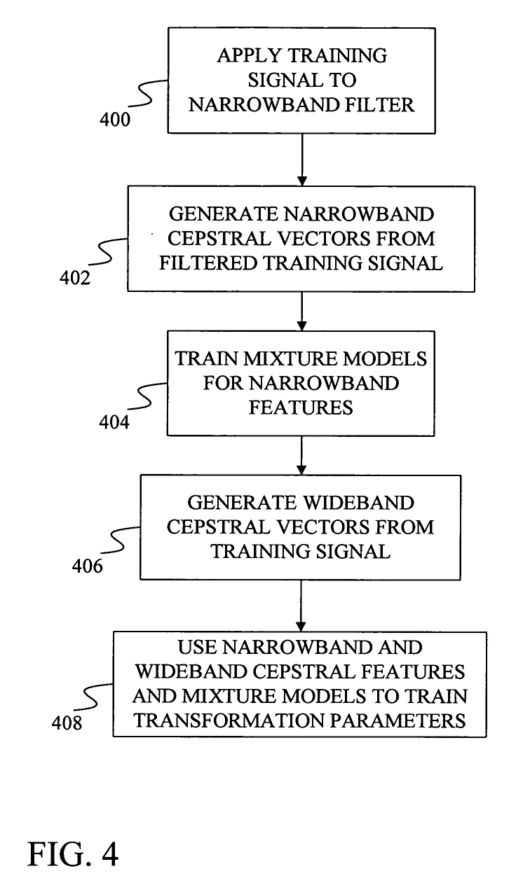

In order to perform the calculation of EQ. 5, parameters that define the posterior probability p(s|x) and the transformation parameters {A₁ . . . Aₛ} must be trained. FIG. 3 provides a block diagram of elements used to train these parameters and FIG. 4 provides a flow diagram of a method of performing such training.

At step 400 of FIG. 4, a training signal 300 of FIG. 3 is applied to a narrowband filter 304. Narrowband filter 304 can be an actual telephone network, such as a public switched telephone network, a cellular network, or a Voice over IP network, or a set of filters that simulate the way in which a signal is filtered as it passes through a telephone network. Under one embodiment, the signal is filtered according to the G.712 telephony channel specification. The signal may represent many different types of information including speech or music.

In some embodiments, the electrical signal is sampled before being applied to the filter. In particular, the electrical signal can be sampled at 16 kHz to provide wideband digital samples of the speech. In narrowband filter 304, these digital samples are down sampled to 8 kHz and then filtered according to the G.712 telephony channel specification. The filtered values are then upsampled back to 16 kHz.

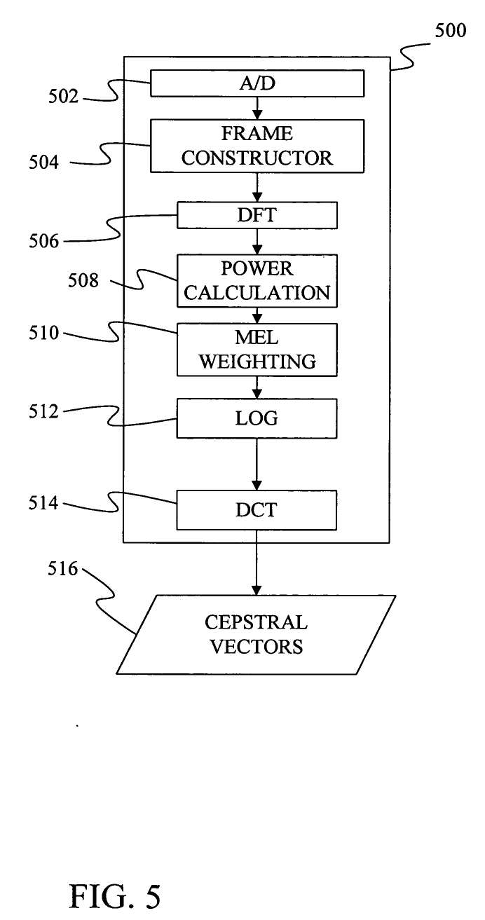

The narrowband signal provided by narrowband filter 304 is then used to generate narrowband cepstral feature vectors as step 402 using a narrowband cepstral generator 306. FIG. 5 provides a block diagram of elements in a cepstral vector generator such as narrowband cepstral vector generator 306.

In cepstral vector generator 500 of FIG. 5, an analog-to-digital converter converts an analog input signal to a set of digital values by sampling the signal. In embodiments in which narrowband filter 304 samples the signal as part of filtering, analog-to-digital converter 502 is not needed. In one embodiment, analog-to-digital converter 502 samples the signal at 16 kHz.

The digital samples provided by analog-to-digital converter 502 are provided to a frame constructor 504, which groups the digital samples into frames. Typically, each frame is windowed by multiplying the frame's samples by a windowing function such as a Hamming window. The frame's digital samples are provided to a Discrete Fourier Transform (DFT) 508, which transform the frames of time-domain samples into frames of frequency-domain samples.

The magnitudes of the frequency domain values from DFT 506 are squared by a power calculation 508 to form a power spectrum, which is weighted by a weighting matrix 510. Under some embodiments, weighting matrix 510 performs Mel-scale weighting. Because the narrowband filter removes certain frequency components, any values in the power spectrum for those frequency components is noise created during sampling. To remove this noise, weighting matrix 510 can apply a weight of zero to the frequency components that are removed by narrowband filter 304. In some embodiments, this is done by removing the rows in a standard Mel-scale weighting matrix that apply non-zero weights to the frequency components that are filtered out by the narrowband filter.

The logarithm of each weighted component is then computed by logarithm 512. The output of log 512 is a set of log spectral vectors, with one vector per frame.

The spectral vectors are converted into cepstral vectors 516 by a discrete cosine transform (DCT) 514. If a standard Mel-scale weighting matrix was modified to remove rows associated with some of the frequency components, the standard discrete cosine transform matrix will also be modified to remove columns so that the matrix multiplication can be performed.

The narrowband training cepstral vectors 308 produced by cepstral vector generator 306 of FIG. 3 are used at step 404 by mixture model training modules 310 to train narrowband mixture models 312. Under one embodiment, the narrowband cepstral feature vectors are grouped into mixture components and the mean and variance of each mixture component is determined using a conventional expectation maximization algorithm. The expectation maximization algorithm is an iterative algorithm in which the groupings of cepstral feature vectors into mixture components is refined based on some loss function during each iteration. Once the cepstral vectors have been grouped into mixture components, the prior probability for each mixture component s can be determined. The distribution of cepstral vectors within a mixture component is defined using a Gaussian distribution under one embodiment such that:

$$p ( x \text{\vert} s ) = N ( x ; {μ}_{s} , {\sum }_{s} ) \qquad EQ . 6$$

where μₛ is the mean for mixture component s and Σₛ is the covariance for mixture component s, which is assumed to be a diagonal matrix.

At step 406, wideband training cepstral vectors 316 are formed by a wideband cepstral vector generator 314 from training signal 300. Cepstral vector generator 314 forms the cepstral vectors using the components discussed above for cepstral vector generator 500 of FIG. 5. Because the wideband training signal includes more frequency components, weighting matrix 510 applies weights to more frequency components in wideband cepstral vector generator 314 than in narrowband cepstral vector generator 306. For example, in one embodiment, a standard Mel-scale weighting matrix is used in wideband cepstral vector generator 314 where a reduced-row Mel-scale weighting matrix is used in narrowband cepstral vector generator 306. In such an embodiment, discrete cosine transform 514 will have more columns in wideband cepstral vector generator 314 than in narrowband cepstral vector generator 306.

At step 408, the narrowband training cepstral vectors 308, the wideband training cepstral vectors 316, and mixture model parameters 312 are used by a transformation training module 318 to form transformation parameters 320. Under one embodiment, a maximum likelihood estimate of the transformation parameters is given by:

$${A}_{s}^{′} = ( {\sum }_{t = 1}^{T} p ( s \text{\vert} {x}_{t} ) {z}_{t} {x}_{t}^{′ T} ) {( {\sum }_{t = 1}^{T} p ( s \text{\vert} {x}_{t} ) {x}_{t}^{′} {x}_{t}^{′ T} )}^{- 1} \qquad EQ . 7$$

where T is the number of training feature vectors, xₜ is a narrowband feature vector at time t and zₜ is a wideband feature vector at time t and where p(s|xₜ) is determined as:

$$p ( s \text{\vert} x ) = \frac{p ( x \text{\vert} s ) p ( s )}{{\sum }_{{s}^{′} = 1}^{S} p ( x \text{\vert} {s}^{′} ) p ( {s}^{′} )} \qquad EQ . 8$$

where p(x|s) is the probability of the narrowband cepstral feature vector given the mixture component s and is determined from the Gaussian distribution parameters μₛ and Σₛ, p(s) is the prior probability of mixture component s, and the summation in the denominator is taken over all mixture components (states) S.

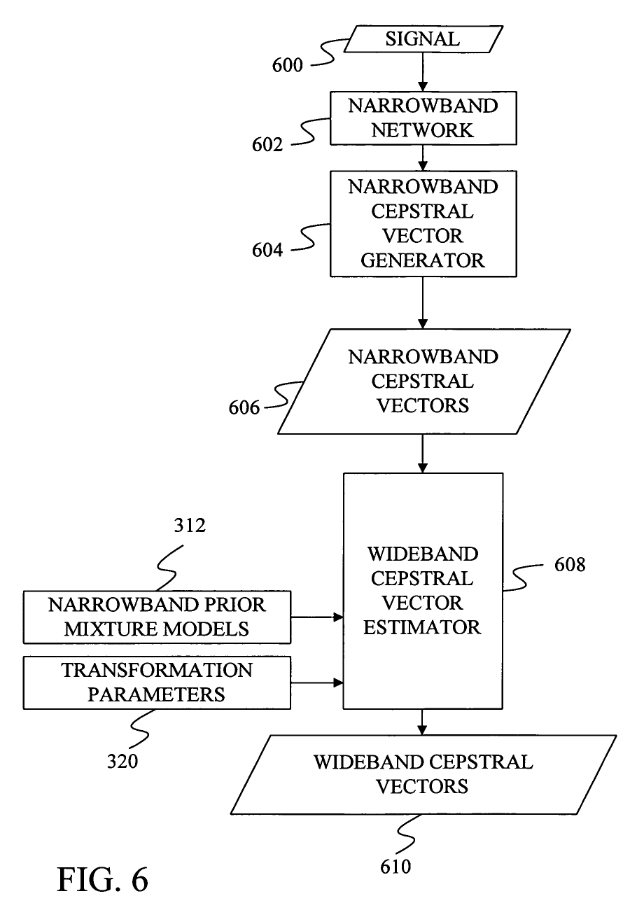

Once the narrowband mixture models and the transformation parameters have been trained they may be used to extend narrowband cepstral vectors to form wideband cepstral vectors. A block diagram of elements used to extend such narrowband cepstral vectors is shown in FIG. 6.

In FIG. 6, a signal 600 passes through a narrowband network 602 such as a telephone network. The narrowband network filters the signal resulting in the removal of some frequency components. For example, signal 600 may have a frequency range of 50-8000 Hz and the output of narrowband network 602 may have a frequency range between 300-3400 HZ.

The narrowband signal from narrowband network 602 is converted into narrowband cepstral vectors 606 by a narrowband cepstral vector generator 604. Narrowband cepstral vector generator 604 works in a manner similar to that discussed above for narrowband cepstral vector generator 306.

Narrowband cepstral vectors 606 are provided to wideband cepstral vector estimator 608 together with narrowband mixture models 312 and transformation parameter 320. Wideband cepstral vector estimator 608 uses this information to generate wideband cepstral vectors 610. In particular, for each narrowband cepstral vector, wideband cepstral vector estimator 608 uses EQs. 5 and 8 above along with the narrowband mixture model parameters 312 and transformation parameters 320 to identify an expected value for a wideband cepstral vector. This expected value is output as the wideband cepstral vector 610.

The wideband cepstral vectors generated in FIG. 6 may be used to generate a corresponding wideband spectral envelope. In particular, the spectral envelope corresponding to a power spectrum |Z|² is estimated as:
Ŝ_{z}=W^{†} exp(C^{†}\hat{z}) EQ. 9
where W^{†} and C^{†} are the pseudoinverses of the weighting matrix, and the discrete cosine transform matrix, respectively, that are used in forming the wideband cepstral training vectors.

Under a further embodiment of the present invention, the bandwidth extension technique described above is integrated with feature enhancement to form a clean wideband cepstral vector z from a noisy narrowband vector y.

In such an embodiment, the narrowband clean cepstral vector x is hidden and the expected value of the wideband clean spectral value must be estimated from a noisy narrowband cepstral vector such that:

$$E [ z \vert y ] = {\sum }_{s = 1}^{S} \int z ( \int p ( z , x , s \text{\vert} y ) ⅆ x ) ⅆ z \qquad EQ . 10$$

Notice that rather than relying on a point estimate of the narrowband clean spectral vector x, EQ. 10 marginalizes over all values of x. This will make the solution more robust to estimation errors. Using Bayes' rules and this marginalization of x, EQ. 10 can be written as:

$$E [ z \text{\vert} y ] = {\sum }_{s = 1}^{S} p ( s \text{\vert} y ) \int zp ( z \text{\vert} y , s ) ⅆ z \qquad EQ . 11$$

To estimate the parameters of p(z|y,s) it is first noted that:
p(z|y,s)=∫p(z|x,y,s)p(x|y,s)dx EQ. 12

The first term on the right hand side of EQ. 12 can be simplified to p(z|x,s) because given x, y provides no additional information about z. If the transformation model of EQ. 1 is used, this conditional probability can be defined as:
p(z|x,s)=N(z;Aₛx+bₛ,I)=N(z;Aₛ′x′,I) EQ. 13

The second term on the right hand side of EQ. 12 is a state conditional posterior distribution. Under one embodiment, this posterior distribution is also modeled as a Gaussian. Thus, if the posterior distribution of x is expressed as:
p(x|y,s)=N(x;νₛ,Φₛ) EQ. 14
then p(z|y,s) can be expressed as:
p(z|y,s)=N(z;Aₛ′νₛ′,Aₛ^{T}ΦₛAₛ+I) EQ. 15

Substituting EQ. 15 into EQ. 11, the final expression for the expected value of the clean wideband spectral value is:

$$\hat{z} = E [ z \text{\vert} y ] = {\sum }_{s = 1}^{S} p ( s \text{\vert} y ) {A}_{s}^{′} {v}_{s}^{′} \qquad EQ . 16$$

where νₛ′=[ν1].

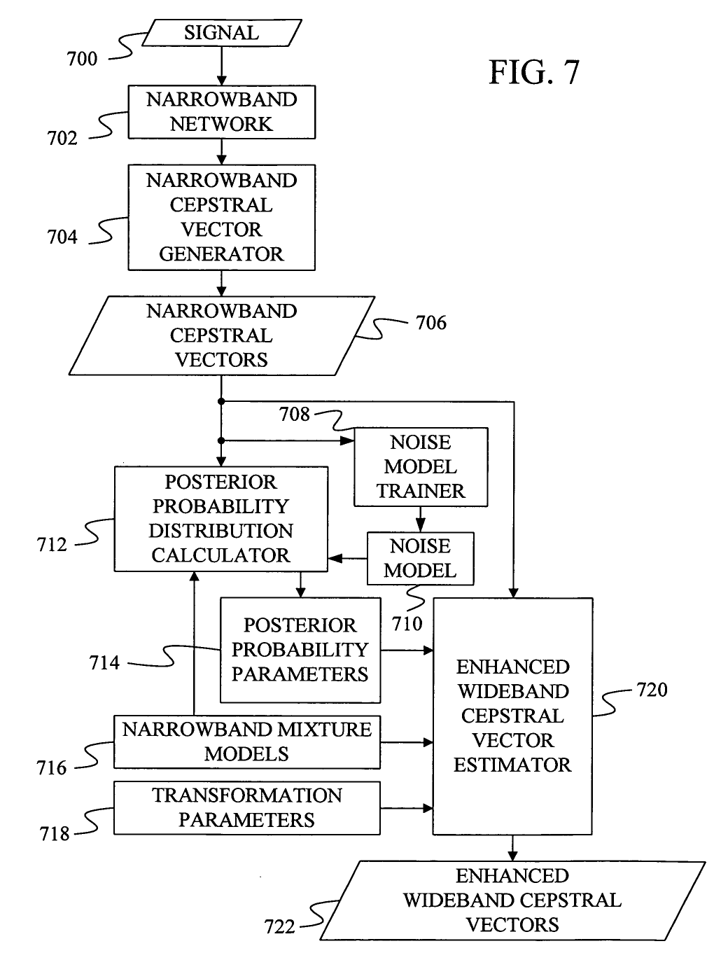

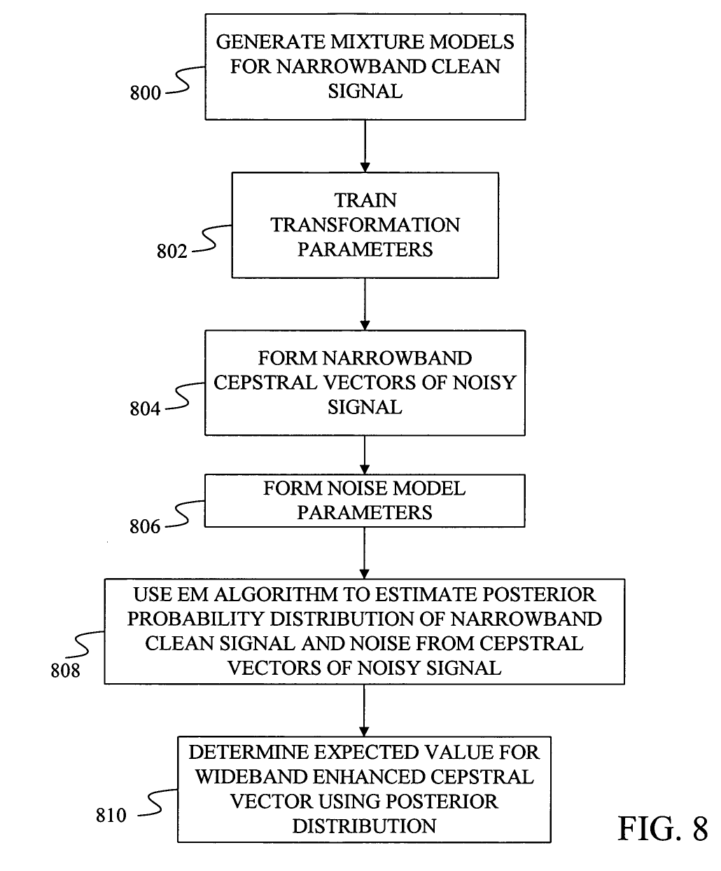

FIG. 7 provides a block diagram and FIG. 8 provides a flow diagram of a system that produces enhanced wideband cepstral vectors from a noisy narrowband signal.

In steps 800 and 802, the mixture models for narrowband clean signals and the transformation parameters are trained as discussed above in steps 404 and 408 of FIG. 4. Note that the transformation parameters can be trained either using narrowband and wideband clean training signals or enhanced narrowband training signals and clean wideband training signals or enhanced narrowband training signals and enhanced wideband training signals, where enhanced training signals are noisy signals that have been enhanced to remove at least some noise.

At step 804, narrowband cepstral vectors are formed from a noisy signal. As shown in FIG. 7, a signal 700 passes through a narrowband network 702 producing a narrowband noisy signal that is converted into noisy narrowband cepstral vectors 706 by narrowband cepstral vector generator 704. The manner of generating narrowband cepstral vectors 706 is the same as discussed above in connection with narrowband cepstral vector generator 306.

At step 806, the narrowband cepstral vectors are provided to a noise model trainer 708, which uses cepstral vectors that represent periods of noise to generate parameters that describe a noise model 710. This noise model provides a Gaussian distribution for the probability of noise values.

At step 808, the narrowband cepstral vectors of the noisy signal are provided to a posterior probability distribution calculator 712, which uses an expectation maximization algorithm to estimate the posterior probability distribution p(x|y,s). Under one embodiment, this posterior probability distribution is estimated using an iterative process that relies on a Taylor series expansion to iteratively estimate a mean for a distribution of signal-to-noise ratios r. In particular, the mean signal-to-noise ratio, \hat{μ}ₛ^{r}, for a mixture component s is calculated as:

$$\begin{matrix}{\hat{μ}}_{s}^{r} = {{\hat{σ}}_{s}^{r} ( {F}_{s}^{o} - I )}^{T} {( {σ}_{s}^{x} )}^{- 1} ( y - {f}_{s}^{o} + {F}_{s}^{o} \cdot {r}_{s}^{o} - {μ}_{s}^{x} ) + {\hat{σ}}_{s}^{r} {{F}_{s}^{o} ( {σ}^{n} )}^{- 1} ( y - {f}_{s}^{o} + {F}_{s}^{o} \cdot {r}_{s}^{o} - {μ}^{n} ) \\ where \text{:} & EQ . 17 \\ {( {\hat{σ}}_{s}^{r} )}^{- 1} = {( {F}_{s}^{o} - I )}^{T} {( {σ}_{s}^{x} )}^{- 1} ( {F}_{s}^{o} - I ) + {{F}_{s}^{oT} ( {σ}^{n} )}^{- 1} {F}_{s}^{o} & EQ . 18 \\ {f}_{s}^{o} = f ( {r}_{s}^{o} ) = ln ( {e}^{{r}_{s}^{o}} + 1 ) & EQ . 19 \\ {F}_{s}^{o} = F ( {r}_{s}^{o} ) = diag ( \frac{1}{1 + {e}^{- {r}_{s}^{o}}} ) & EQ . 20\end{matrix}$$

rₛ^{o} is the Taylor series expansion point, μₛ^{x} and σₛ^{x} are the mean and variance of the prior probability distribution for the clean narrowband training signal for mixture s, and μⁿ and σⁿ are the mean and variance for the noise in noise model 710. In each iteration, the mean signal-to-noise ratio is set as the Taylor Series expansion point for the next iteration. The iterations are repeated until the mean signal-to-noise ratio is stable for all of the mixture components. The mean νₛ of the posterior probability p(x|y,s) is then determined as:
νₛ≈y−ln(e^{\hat{μ}}^{ₛ}^{r}+1)+\hat{ν}ₛ^{r} EQ. 21

This mean represents a mean enhanced narrowband cepstral vector, which is stored as posterior probability parameters 714 of FIG. 7.

Note that the technique discussed above for determining the posterior probability is just one example. There are many different techniques that are available for determining the parameters of the posterior probability of the enhanced narrowband cepstral vector.

At step 810, the expected value for the enhanced wideband cepstral vector is determined by enhanced wideband cepstral vector estimator 720 using posterior probability parameters 714, narrowband mixture models 716, which were formed in step 800, transformation parameters 718, which were formed in step 802 and noisy narrowband cepstral vectors 706. In particular, these parameters and vectors are applied to EQ. 16, which is repeated here:

$$\begin{matrix}\hat{z} = E [ z \vert y ] = {\sum }_{s = 1}^{S} p ( s \vert y ) {A}_{s}^{′} {v}_{s}^{′} \\ where \text{:} & EQ . 16 \\ p ( s \text{\vert} y ) = \frac{p ( y \text{\vert} s ) p ( s )}{{\sum }_{{s}^{′} = 1}^{S} p ( y \text{\vert} {s}^{′} ) p ( {s}^{′} )} & EQ . 22\end{matrix}$$

where p(y|s) and p(s) are determined from the narrowband mixture model parameters and the noisy speech. This results in enhanced wideband cepstral vectors 722.

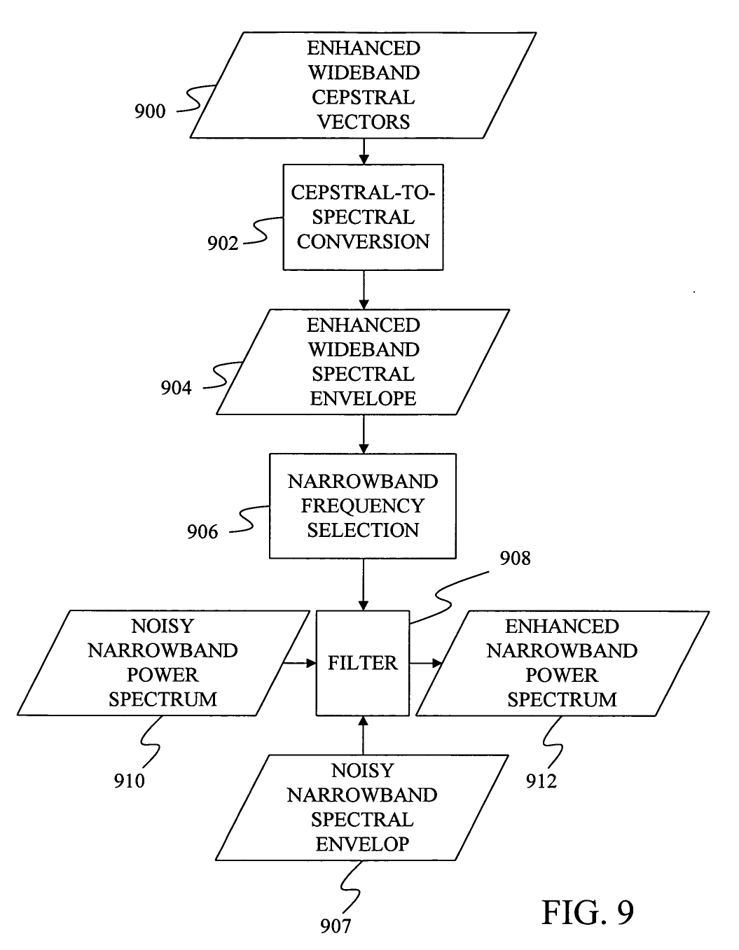

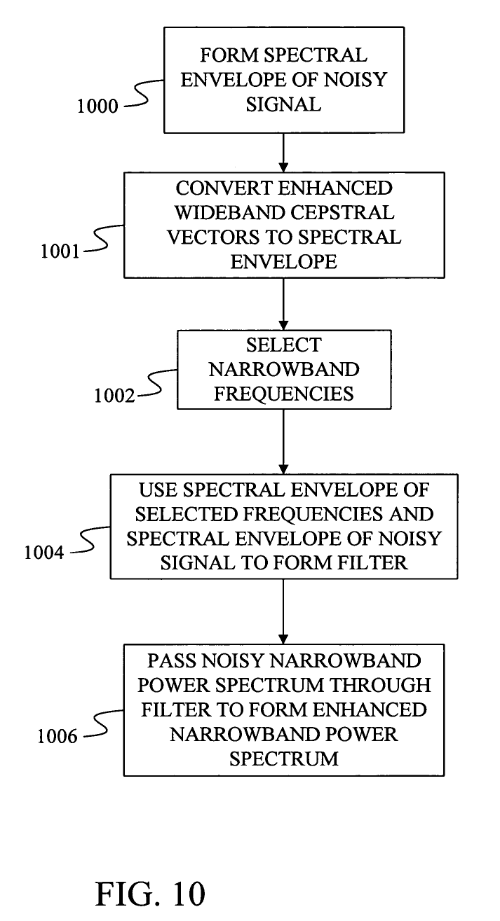

Under one embodiment, the enhanced wideband cepstral vectors are used to construct a filter that can filter the noisy narrowband power spectrum. FIG. 9 provides a block diagram of elements used to construct such a filter and FIG. 10 provides a flow diagram of such a method. In step 1000 of FIG. 10, a noisy narrowband spectral envelope 907 is constructed from the noisy speech signal. Such an envelope is formed during construction of the noisy narrowband cepstral vectors that are enhanced to form the enhanced wideband cepstral vectors as discussed above.

At step 1001, enhanced wideband cepstral vectors 900 are converted by a cepstral-to-spectral conversion unit 902 into an enhanced wideband spectral envelope 904. This is performed using EQ. 9 above. At step 1002 narrowband frequencies are selected by a narrowband frequency selection unit 906 from the wideband spectral envelope. At step 1004, the selected frequencies of the spectral envelope are used with the noisy signal spectral envelope 907 to form filter 908. Specifically, the filter is defined as:
H=Ŝ_{z}/S_{y} EQ. 23
where H is the filter, Ŝ_{z} is the spectral envelope of the enhanced signal and S_{y} is the spectral envelope of the noisy narrowband signal.

At step 1006, a noisy narrowband power spectrum 910 is passed through filter 908 to form enhanced narrowband power spectrum 912. In terms of an equation:
|\hat{Z}|²=H|Y|² EQ. 24

The enhanced narrowband power spectrum can be extended to the wideband power spectrum by using the portion of the wideband spectral envelope beyond the narrowband to define the spectral envelope beyond the narrowband. This enhanced wideband power spectrum can then be used to generate a wideband waveform.

Under one embodiment, the wideband waveform is formed by first converting the enhanced wideband power spectrum into the,LPC domain. This is done by perform an Inverse Discrete Fourier Transform, identifying autocorrelation parameters and constructing an all-pole LPC filter from the autocorrelation parameters.

A frame of the narrowband speech signal is then applied to the inverse of the LPC filter to identify a narrowband excitation signal. The narrowband excitation signal is then modulated to the upper frequency band and combined with the original narrowband excitation to form a complete wideband excitation signal. The complete wideband excitation signal is then applied to the LPC filter to form the wideband speech signal.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
converting a narrowband power spectrum into a narrowband cepstral vector; and
estimating a wideband cepstral vector from the narrowband cepstral vector, the wideband cepstral vector representing more frequency components than the narrowband cepstral vector.

2. The method of claim 1 wherein estimating a wideband cepstral vector comprises using transformation model parameters that describe a piecewise linear transformation from a narrowband cepstral vector to a wideband cepstral vector.

3. The method of claim 2 further comprising training the transformation model parameters using stereo data comprising narrowband cepstral vectors and wideband cepstral vectors that represent a same signal.

4. The method of claim 2 wherein using transformation model parameters comprises using separate transformation parameters for at least two mixture components in a set of mixture components.

5. The method of claim 4 wherein estimating a wideband cepstral vector comprises forming a separate wideband cepstral vector for each mixture component in the set of mixture components and estimating the wideband cepstral vector as the weighted sum of the separate wideband cepstral vectors.

6. The method of claim 1 wherein estimating a wideband cepstral vector comprises estimating an enhanced wideband cepstral vector from a noisy narrowband cepstral vector.

7. The method of claim 6 wherein estimating an enhanced wideband cepstral vector comprises estimating a clean narrowband cepstral vector based on the noisy narrowband cepstral vector.

8. The method of claim 1 wherein converting a narrowband power spectrum into a narrowband cepstral vector comprises applying Mel weighting to the narrowband power spectrum.

9. A computer-readable medium having computer-executable instructions for performing steps comprising:
receiving narrowband cepstra formed from power spectrums of a signal;
receiving wideband cepstra for the same signal; and
using the narrowband cepstra and the wideband cepstra to train transformation model parameters that can be used to transform narrowband cepstra into wideband cepstra.

10. The computer-readable medium of claim 9 wherein the transformation parameters provide a piecewise linear transformation from narrowband cepstra to wideband cepstra.

11. The computer-readable medium of claim 9 wherein training the transformation parameters comprises training separate transformation parameters for at least two states.

12. The computer-readable medium of claim 9 further comprising forming wideband cepstra using the transformation parameters.

13. The computer-readable medium of claim 12 wherein forming wideband cepstra using the transformation parameters comprises calculating a weighted sum over a set of states.

14. The computer-readable medium of claim 12 wherein forming wideband cepstra comprises forming enhanced wideband cepstra based on noisy narrowband cepstra.

15. The computer-readable medium of claim 14 wherein forming enhanced wideband cepstra comprises identifying a mean enhanced narrowband cepstra from the noisy narrowband cepstra.

16. The computer-readable medium of claim 14 further comprising forming a filter based on the enhanced wideband cepstra.

17. A method comprising:
generating noisy narrowband cepstra from a noisy signal; and
generating enhanced wideband cepstra from the noisy narrowband cepstra.

18. The method of claim 17 wherein generating an enhanced wideband cepstrum comprises identifying a mean enhanced narrowband cepstrum from a noisy narrowband cepstrum and using the mean enhanced narrowband cepstrum to generate the enhanced wideband cepstrum.

19. The method of claim 18 wherein generating an enhanced wideband cepstrum comprises using transformation parameters that perform a piecewise linear transformation on the mean enhanced narrowband cepstrum.

20. The method of claim 19 wherein using transformation parameters comprises using separate transformation parameters for at least two states of a set of states.
